(19) United States
(12) Patent Application Publication
(10) Pub. No.: US 2021/0078163 A1
(43) Pub. Date: Mar. 18, 2021

(54) ASSIST DEVICE

(71) Applicant: JTEKT CORPORATION, Osaka (JP)

(72) Inventors: Kazuyoshi OHTSUBO, Chiryu-shi (JP); Hiromichi OHTA, Kariya-shi (JP); Tomoki ARAI, Kitakatsuragi-gun (JP); Mitsuharu OZAKI, Kashiba-shi (JP); Yoshitaka YOSHIMI, Kashiba-shi (JP)

(73) Assignee: JTEKT CORPORATION, Osaka (JP)

(21) Appl. No.: 17/015,278

(22) Filed: Sep. 9, 2020

(30) Foreign Application Priority Data
Sep. 12, 2019 (JP) 2019-166178
Oct. 17, 2019 (JP) 2019-190081

(51) Int. Cl. B25J 9/00; B25J 9/10; A61H 3/00; A61H 1/02

(52) U.S. Cl. CPC B25J 9/0006; B25J 9/104; A61H 3/00; A61H 2201/1652; A61H 2003/007; A61H 2201/1215; A61H 2201/149; A61H 1/0262

(57) ABSTRACT

An assist device includes a first harness, a second harness, a belt body, a mechanical unit and an attachment-detachment portion. The first harness is configured to be fitted to at least one of a shoulder region and a breast region of a user. The second harness is configured to be fitted to a leg region or a waist region of the user. The belt body is provided so as to extend to the first harness and to the second harness along a back side of the user. The mechanical unit includes an actuator provided in one harness of the first harness and the second harness and configured to wind and unwind a part of the belt body. The attachment-detachment portion is provided in the harness and the mechanical unit and is configured to detachably attach the mechanical unit to the harness.

### CROSS-REFERENCE TO RELATED APPLICATION

This application claims priority to Japanese Patent Application No.

2019-166178 filed on Sep. 12, 2019 and Japanese Patent Application No. 2019-190081 filed on Oct. 17, 2019, each incorporated herein by reference in its entirety.

### BACKGROUND

### 1. Technical Field

The present disclosure of the present disclosure relates to an assist device.

### 2. Description of Related Art

Various assist devices that assist a user's work by being worn on the body of the user (human being) have been proposed. For example, even where a user lifts a heavy object, an assist device enables the user to perform the work with a small strength (burden). Such assist device is disclosed in, for example, Japanese Unexamined Patent Application Publication No. 2018-199205 (JP 2018-199205 A).

### SUMMARY

The assist device disclosed in JP 2018-199205 A includes a frame made of, e.g., a metal, the frame being fitted to a user. An output of an actuator mounted in the frame is transmitted to the upper body and the lower body of the user through a link mechanism. Consequently, for example, a motion of lifting a heavy object is assisted.

Examples of motions for which a user needs assistance include motions of assisting (helping) a person such as a patient or an elderly person in activities of daily living in addition to motions involving a large burden such as lifting a heavy object. When a user performs work involving a heavy burden, a high-power assist device such as one disclosed in JP 2018-199205 A is effective.

However, when a user assists a person such as a patient or an elderly person, a high-power assist device may be excessive in performance. Also, a high-power assist device uses many rigid members such as a link mechanism and a frame made of, e.g., metal, and has a solid configuration in order to achieve a high output. Therefore, the assist device is heavy in weight and movement of the user is restricted by the rigid members.

Therefore, the inventor of the present disclosure has already proposed assist devices that are light in weight and provide good wear comfort (for example, Japanese Patent Application No. 2019-043462). Each of such assist devices includes a first harness to be fitted to a shoulder region of a user, second harnesses to be fitted to left and right leg regions of the user, a belt body provided so as to extend to the first harness and to the second harness along the back side of the user, and an actuator. The actuator is provided in the first harness and enables winding and unwinding a part of the belt body.

Upon the actuator winding a part of the belt body, tension acts on the belt body. The tension serves as an assist force and acts on the user. Consequently, for example, when the user assists a person as stated above, a burden is reduced.

When the user performs work including assistance of a person such as a patient or an elderly person, the assist force is not always necessary but unnecessary depending on the work, and also, is totally unnecessary during the user's break time. Therefore, the assist device could be worn each time the assist force is necessary; however, it takes time to put on the assist device. Also, the actuator that winds the belt body is configured so as to be as light in weight as possible; nevertheless, where the user keeps wearing the assist device during a time period in which the assist force is unnecessary, the weight of the actuator becomes a burden although the burden is small.

Therefore, the present disclosure provides an assist device that is light in weight, provides a good wear comfort, enables a user to be relieved of a burden where no assist force is necessary, and when an assist force is necessary for work, enables quickly responding to the work.

An assist device according to a first aspect of the present disclosure includes a first harness, a second harness, a belt body, a mechanical unit and an attachment-detachment portion. The first harness is configured to be fitted to at least one of a shoulder region and a breast region of a user. The second harness is configured to be fitted to a leg region or a waist region of the user. The belt body provided so as to extend to the first harness and to the second harness along the back side of the user. The mechanical unit includes an actuator provided in one harness of the first harness and the second harness and configured to wind and unwind a part of the belt body. The attachment-detachment portion is provided in the one harness and the mechanical unit and is configured to detachably attach the mechanical unit to the one harness.

With the assist device according to the first aspect of the present disclosure, the belt body is provided so as to extend to the first harness and to the second harness along the back side of a user. Upon the actuator winding the belt body, tension acts on the belt body. The tension causes generation of an assist force for assisting the user's work, which reduces a burden on the body of the user. The belt body is light in weight and can conform to the body of the user even if the user changes his/her posture, and thus, follows movement of the user. Therefore, an assist device that provides good wear comfort can be provided.

Furthermore, the mechanical unit can be detached from the harness by use of the attachment-detachment portion. Therefore, where no assist force of the actuator is necessary, the user can be relieved of a burden by detaching the mechanical unit from the harness without taking off the assist device itself. Then, where an assist force becomes necessary, the user only needs to attach the mechanical unit to the harness worn by the user, by use of the attachment-detachment portion. Therefore, it becomes possible to quickly respond to work needing an assist force. Note that besides the user of the assist device, work of detachment and attachment of the mechanical unit can be performed by a person other than the user.

In the assist device, tension acting on the belt body in generating an assist force contains a component in a height direction. Therefore, in the assist device according to the first aspect of the present disclosure, the mechanical unit may be provided in the first harness. The attachment-detachment portion may include an elongated hole that is provided in one of the first harness and the mechanical unit and is long in the height direction, and a projection portion provided at the other of the first harness and the mechanical unit and configured to engage with the elongated hole. The elongated hole may have a shape configured to, in a state in which the projection portion is located on one side in a longitudinal direction of the elongated hole, allow the projection portion to be fitted in and separated from the elongated hole and configured to, in a state in which the projection portion is located on another side in the longitudinal direction of the elongated hole, prevent separation between the elongated hole and the projection portion.

With the assist device according to the first aspect of the present disclosure, during tension acting on the belt body in order to provide an assist force, the mechanical unit is pulled downward and the projection portion is kept located on the other side in the longitudinal direction of the elongated hole. Therefore, the mechanical unit does not drop off from the first harness. When the assist force becomes unnecessary, the mechanical unit can be detached from the first harness by moving the mechanical unit upward relative to the first harness to move the projection portion to the one side in the longitudinal direction of the elongated hole. In this way, work of detaching the mechanical unit from the first harness is facilitated. Also, where the mechanical unit is attached to the first harness, it is only necessary that the projection portion be located on the one side in the longitudinal direction of the elongated hole and then be moved to the other side in the longitudinal direction, and work of attaching the mechanical unit to the first harness is thus facilitated.

Furthermore, in the assist device according to the first aspect of the present disclosure, the projection portion may include a thin shaft portion at a base portion of the projection portion and a bulge portion at a tip portion of the projection portion, the bulge portion being thicker than the shaft portion. The elongated hole may include a reduced hole portion on the other side in the longitudinal direction of the elongated hole, the reduced hole portion being configured to, in a state in which the shaft portion is inserted, prevent the bulge portion from passing through the reduced hole portion, and an enlarged hole portion on the one side in the longitudinal direction of the elongated hole, the enlarged hole portion being configured to allow the bulge portion to pass through the enlarged hole portion. The assist device according to the first aspect of the present disclosure enables easy provision of a configuration that, in a state in which the projection portion is located on the one side in the longitudinal direction of the elongated hole, enables the projection portion to be fitted in and be separated from the elongated hole, and in a state in which the projection portion is located on the other side in the longitudinal direction of the elongated hole, prevents separation between the elongated hole and the projection portion.

Also, in the assist device according to the first aspect of the present disclosure, a plurality of sets each including the elongated hole and the projection portion may be provided so as to be aligned in a left-right direction. With the assist device according to the first aspect of the present disclosure, even if a load biased in the left-right direction acts on the mechanical unit from the belt body, the mechanical unit attached to the first harness does not easily rotate.

Also, in the assist device according to the first aspect of the present disclosure, the belt body and the second harness may be connected via a fastener configured to enable the belt body to be separated from the second harness. With the assist device according to the first aspect of the present disclosure, separating the belt body and the second harness from each other by use of the fastener enables the belt body and the mechanical unit to be easily detached together from the first harness and the second harness.

Also, an assist device according to a second aspect of the present disclosure include a first harness, a second harness, a belt body, a mechanical unit and a receiving portion. The first harness is configured to be fitted to at least one of a shoulder region and a breast region of a user. The second harness is configured to be fitted to a leg region or a waist region of the user. The belt body is provided so as to extend to the first harness and to the second harness along the back side of the user. The mechanical unit includes an actuator provided in one harness of the first harness and the second harness and configured to wind and unwind a part of the belt body. The receiving portion is provided in the one harness and is configured to be capable of receiving the mechanical unit and enable the mechanical unit to be taken out from the receiving portion.

With the assist device according to the second aspect of the present disclosure, the belt body is provided so as to extend to the first harness and to the second harness along the back side of a user. Upon the actuator winding the belt body, tension acts on the belt body. The tension causes generation of an assist force for assisting the user's work, which reduces a burden on the body of the user. The belt body is light in weight and can conform to the body of the user even if the user changes his/her posture, and thus, follows movement of the user. Therefore, an assist device that provides good wear comfort can be provided.

Furthermore, the mechanical unit can be taken out from the receiving portion. Therefore, where no assist force of the actuator is necessary, the user can be relieved of a burden by taking the mechanical unit from the receiving portion of the harness without taking off the assist device itself. Then, where an assist force becomes necessary, the user only needs to attach the mechanical unit by putting the mechanical unit in the receiving portion of the harness worn by the user. Therefore, it becomes possible to quickly respond to work needing an assist force. Note that besides the user of the assist device, work of detachment and attachment (putting-in) of the mechanical unit can be performed by a person other than the user.

In the assist device including the receiving portion, tension acting on the belt body in generating an assist force contains a component in a height direction. Therefore, in the assist device according to the second aspect of the present disclosure, the mechanical unit may be provided in the first harness. The receiving portion may include a holding portion configured to prevent the received mechanical unit from moving in the user's own downward, forward and rearward directions, and an opening portion for putting in and taking out the mechanical unit, the opening portion being provided at an upper portion.

With the assist device according to the second aspect of the present disclosure, during tension acting on the belt body in order to provide an assist force, the mechanical unit is pulled downward; however, the holding portion of the receiving portion restricts downward, forward and rearward movement of the mechanical unit. Therefore, the mechanical unit does not drop off from the first harness. When the assist force becomes unnecessary, the mechanical unit can be detached from the first harness by moving the mechanical unit upward relative to the receiving portion of the first harness and taking the mechanical unit out from the opening portion. In this way, work of detaching the mechanical unit from the first harness is facilitated. Also, where the mechanical unit is attached to the first harness, it is only necessary to put the mechanical unit down into the receiving portion from the opening portion of the receiving portion. Work of attaching the mechanical unit to the first harness is easy.

Each of the assist devices according to the first and second aspects of the present disclosure is light in weight, provides a good wear comfort, enables a user to be relieved of a burden where no assist force is necessary, and when an assist force is necessary for the work, enables quickly responding to the work.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a back view illustrating an example of an assist device;

FIG. 2 is a back view of the assist device attached to the body of a user;

FIG. 3 is a side view of the assist device attached to the body of the user;

FIG. 4 is a diagram illustrating the user wearing the assist device in a forward-tilted posture;

FIG. 5 is a diagram of a control box and a belt body;

FIG. 6 is a diagram of parts of attachment of a second belt to second harnesses;

FIG. 7 is a diagram for describing an example of attachment-detachment portions;

FIG. 8 is a diagram for describing another example of the attachment-detachment portions;

FIG. 9 is a diagram of a case where a user wearing an assist device changes his/her posture;

FIG. 10 is a side view illustrating another form of assist device;

FIG. 11 is a diagram illustrating an alteration of the attachment-detachment portions and is a diagram illustrating a state in which a mechanical unit is attached to a first harness;

FIG. 12 is a diagram illustrating the attachment-detachment portions illustrated in FIG. 11 and is a diagram illustrating a state in which the mechanical unit is detached from the first harness;

FIG. 13 is a diagram illustrating another alteration of the attachment-detachment portions;

FIG. 14 is a diagram illustrating an example of a receiving portion included in a first harness;

FIG. 15 is a sectional view along line XV-XV in FIG. 14;

FIG. 16 is a diagram illustrating an alteration of the receiving portion; and

FIG. 17 is a diagram illustrating structures of attachment between shoulder belts and a back body portion.

### DETAILED DESCRIPTION OF EMBODIMENTS

Overall Configuration of Assist Device 10

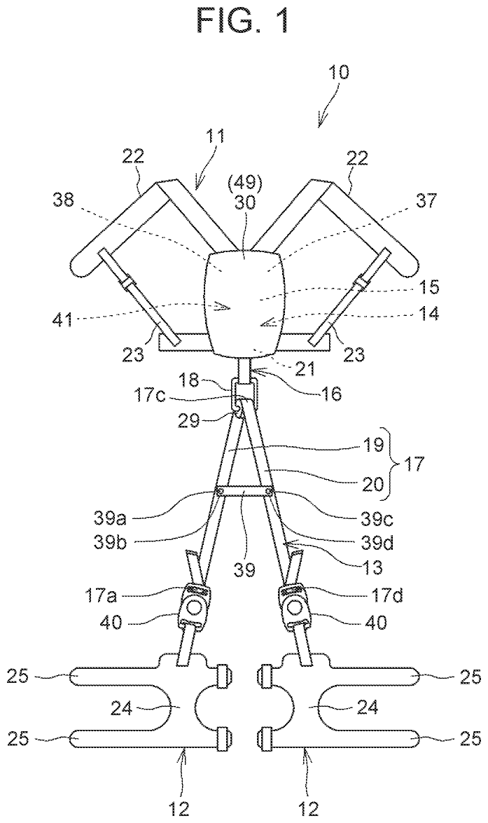

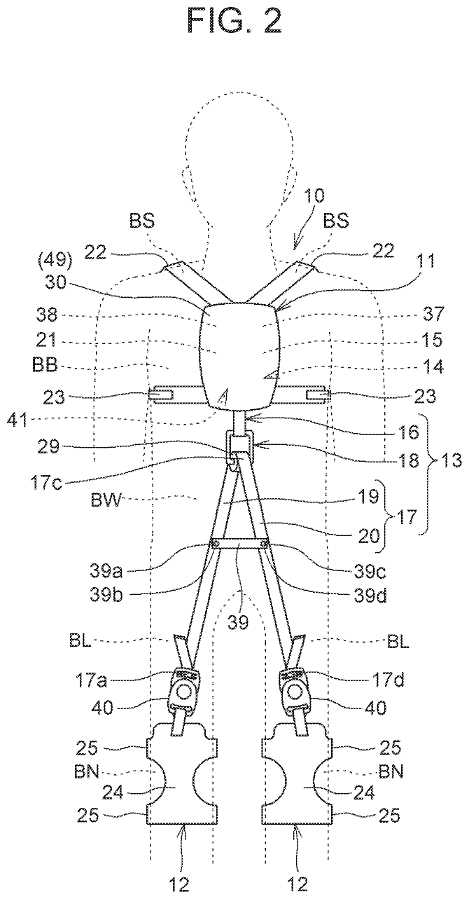

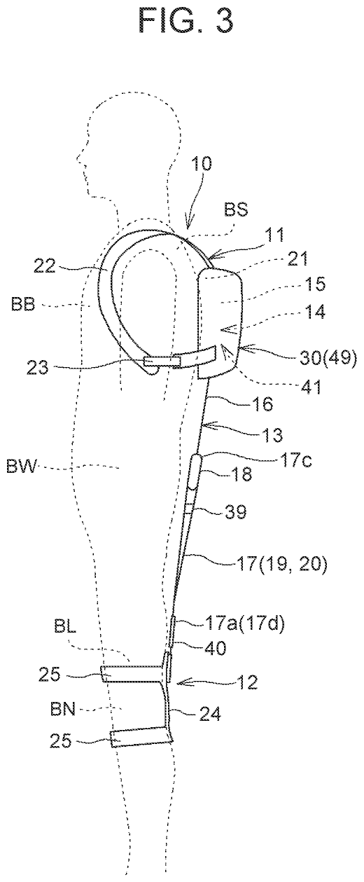

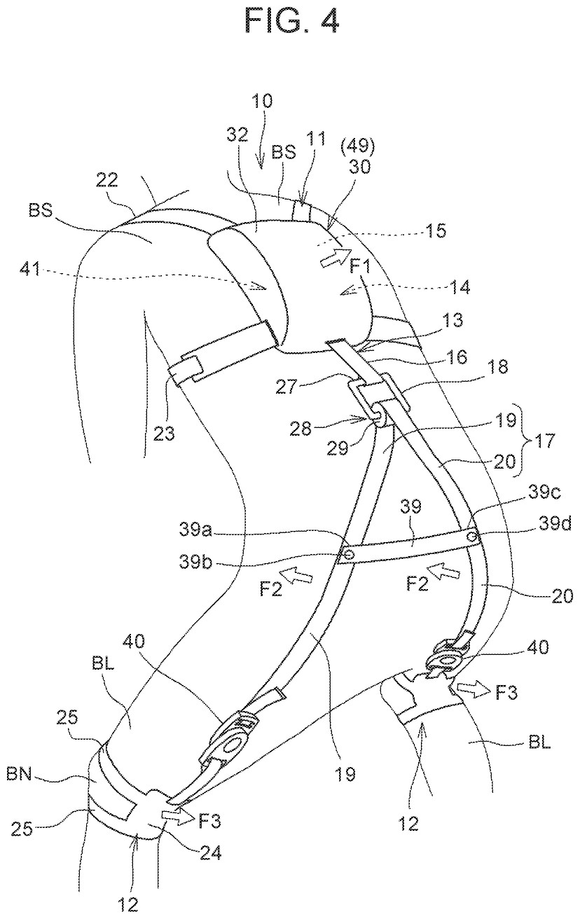

FIG. 1 is a back view illustrating an example of an assist device. FIG. 2 is a back view of the assist device attached to the body of a user. FIG. 3 is a side view of the assist device attached to the body of the user. FIG. 4 is a diagram illustrating the user wearing the assist device having a forward-tilted posture (stooped posture). The assist device 10 illustrated in FIG. 1 includes one first harness 11 to be fitted to left and right shoulder regions BS, which are parts of the body of a user (human being), and two second harnesses 12 to be fitted to left and right leg regions BL, which are other parts of the body of the user. The first harness 11 only needs to be fitted to at least either the shoulder regions BS or a breast region BB of the user, and also, may have a form other than the illustrated form. In the present disclosure, the second harnesses 12 are fitted to respective knee regions BN in the leg regions BL. The second harnesses 12 also may have a form other than the illustrated form.

In the assist device 10 of the present disclosure, “left” and “right” are the user's own left and right when the user has an upright posture wearing the assist device 10 and “front” and “rear” are the user's own front and rear, “upper (up)” and “lower (down)” are the user's own upper and lower sides. “Upper (up)” are the head side of the user and “lower (down)” are the foot side of the user.

The assist device 10 includes a belt body 13, an actuator 14, a controller 15, a battery 37 and a sensor 38 in addition to the first harness 11 and the left and right second harnesses 12.

The first harness 11 is fitted to the shoulder region BS of the user. One second harness 12 is fitted to the left knee region BN of the user. The other second harness 12 is fitted to the right knee region BN of the user. The left second harness 12 and the right second harness 12 are bilaterally symmetrical and have a same configuration. The first harness 11 and the two second harnesses 12 are fitted to respective regions away from each other across a waist region BW, which is a joint of the user, that is, the shoulder regions BS and the leg regions BL.

The first harness 11 is formed of, e.g., flexible fabric. The first harness 11 includes a back body portion 21 to be fitted to the back of the user, and shoulder belts 22 and underarm belts 23 connecting with the back body portion 21. The shoulder belts 22 and the underarm belts 23 allow the back body portion 21 to be held on the back of the user. The underarm belts 23 connect the back body portion 21 and the respective shoulder belts 22 and are adjustable in length. By adjustment of the length of each underarm belt 23, the back body portion 21 is brought into close contact with the user. The first harness 11 is fitted to the shoulder regions BS so as to be incapable of moving forward and backward, leftward and rightward, and upward and downward. The first harness 11 may include a stiff member, for example, as a part to be hung on the shoulder regions BS.

The second harnesses 12 are each formed of, e.g., flexible fabric. Each second harness 12 includes a knee body portion 24 to be fitted to the rear side of the relevant knee region BN of the user, and knee belts 25 provided so as to extend from the knee body portion 24. The knee belts 25 extend around the knee region BN at respective positions above and below the knee region BN, and the distal end side of each knee belt 25 is fixed to the knee body portion 24. The knee belt 25 can be adjusted in length of wrapping of the knee region BN, by a locking member such as a belt and a buckle or a hook-and-loop fastener. By the adjustment, the knee body portion 24 is brought into a close contact with the rear side of the knee region BN. The second harnesses 12 are fitted to the knee regions BN so as to be incapable of moving forward and backward, leftward and rightward, and upward and downward.

The belt body 13 is provided along the back side of the user so as to connect the first harness 11 and the second harness 12. The belt body 13 includes a first belt 16 provided on the upper body side, a second belt 17 provided on the lower body side, and a joining member 18 joining the first belt 16 and the second belt 17. Each of the first belt 16 and the second belt 17 is long and flexible. The joining member 18 is made of a metal and is formed by a rectangular ring-like body called “rectangular ring”.

Each of the first belt 16 and the second belt 17 is a band-like member made of fabric or leather and is bendable along a shape of the body. Note that each of the first belt 16 and the second belt 17 may be a string-like belt (wire-like member). Each of the first belt 16 and the second belt 17 of the present disclosure is a non-stretchable member, that is, has a characteristic of being hard to stretch in a longitudinal direction of the first belt 16 or the second belt 17 or a characteristic of not stretching in the longitudinal direction.

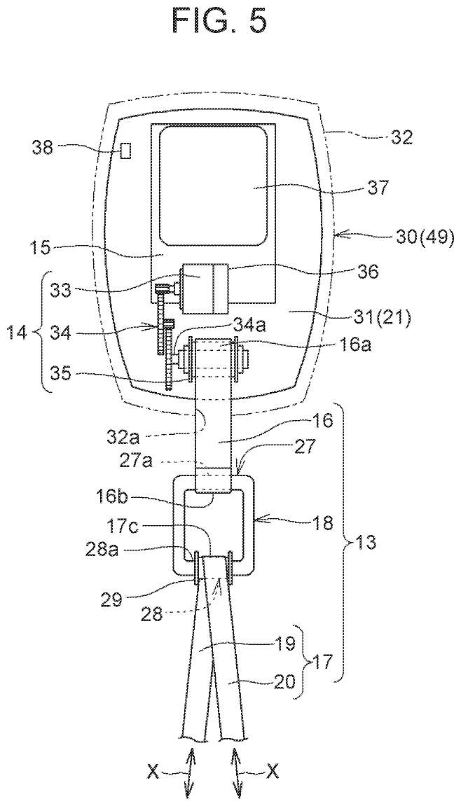

The assist device 10 of the present disclosure includes a control box 30. The control box 30 is provided in the back body portion 21 of the first harness 11. FIG. 5 is a diagram of the control box 30 and the belt body 13. The control box 30 includes a base 31 having a plate-like shape and a cover 32 that covers the base 31. In order to describe an inner structure of the control box 30, in FIG. 5, the cover 32 is indicated by an imaginary line (alternate long and two short dashes line).

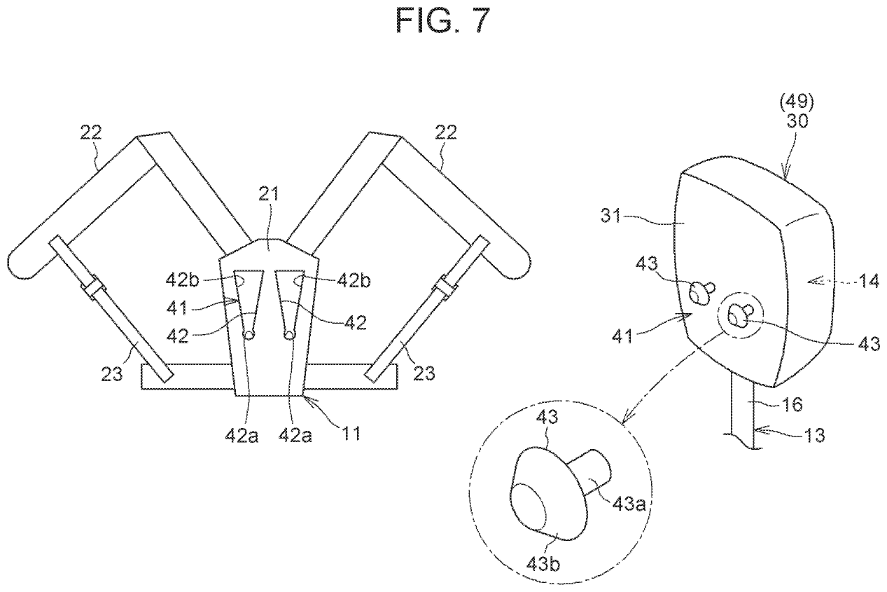

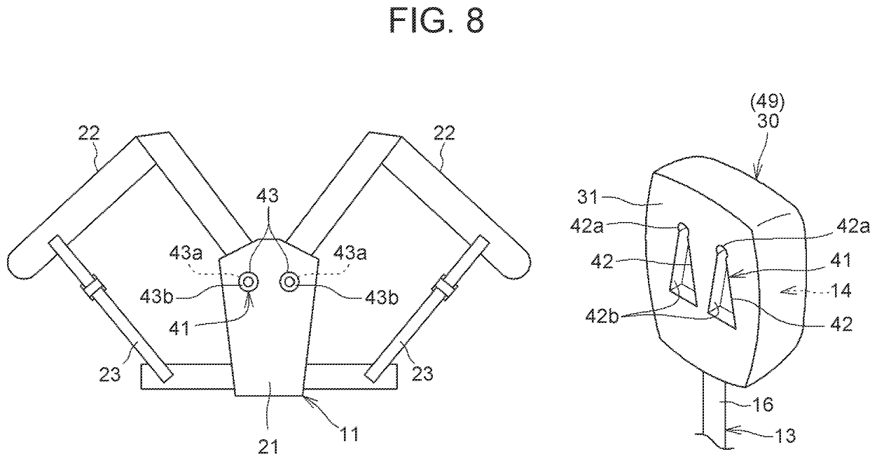

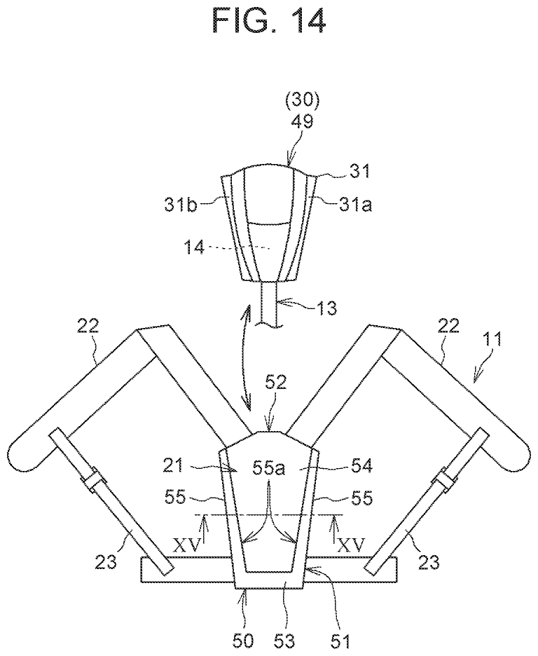

The base 31 is attached to the back body portion 21 of the first harness 11 in such a manner that the base 31 is detachable by use of attachment-detachment portions 41 (see FIGS. 7 and 8). The control box 30 is a mechanical unit 49 including the actuator 14, etc., and the mechanical unit 49 is detachable from the first harness 11 by use of the attachment-detachment portions 41. The attachment-detachment portions 41 will be described later. Alternatively, the mechanical unit 49 may be detachable from the first harness 11 by use of a later-described receiving portion 50 (see, for example, FIG. 14).

In FIG. 5, the actuator 14, the controller 15, the battery 37, the sensor 38, etc., are provided in space between the base 31 and the cover 32. Besides the actuator 14, the controller 15, the battery 37 and the sensor 38 are included in the mechanical unit 49. In the cover 32, an opening (cutout) 32a is formed and the first belt 16 extends through the opening 32a.

The actuator 14 is provided inside the control box 30. In other words, the actuator 14 is provided in the first harness 11. The actuator 14 enables winding and unwinding of a part of the belt body 13. For that purpose, the actuator 14 includes a motor 33, a reducer section 34 and a drive pulley 35. The motor 33 is a brushless DC motor. The motor 33 can rotate with a predetermined torque at a predetermined rotation frequency based on a drive signal output from the controller 15. The motor 33 can rotate in forward and reverse directions based on a drive signal output from the controller 15.

A parameter relating to rotation, such as a rotational angle, a rotation speed or a rotation frequency, of the motor 33 is detected by a rotation detector 36 attached to the motor 33. The rotation detector 36 of the present disclosure is a rotary encoder but may be a Hall sensor or a resolver. A result of detection by the rotation detector 36 is input to the controller 15. By the controller 15 controlling operation of the motor 33 based on the result of detection, the assist device 10 can generate a proper assist force.

The reducer section 34 is formed by a plurality of gears, reduces the rotation frequency of the motor 33 and rotates an output shaft 34a of the reducer section 34. The drive pulley 35 is joined to the output shaft 34a and thus rotates together with the output shaft 34a. One end portion 16a side of the first belt 16 is attached to the drive pulley 35. Upon the drive pulley 35 rotating in one direction by forward rotation of the motor 33, the first belt 16 is wound on the drive pulley 35. Upon the drive pulley 35 rotating in the other direction by reverse rotation of the motor 33, the first belt 16 is unwound from the drive pulley 35.

As above, the actuator 14 includes the drive pulley 35 that can wind the belt body 13, and the motor 33 for making the drive pulley 35 perform an operation of winding the belt body 13. The first belt 16 is wound and unwound by the actuator 14.

The controller 15 is formed of a control unit including a microcomputer. The controller 15 controls operation of the actuator 14 (motor 33). As the sensor 38, an acceleration sensor is provided. A signal from the sensor 38 is input to the controller 15. The controller 15 can estimate a posture of the user based on the signal from the sensor 38.

The battery 37 supplies electric power to the controller 15, the motor 33, the rotation detector 36 and the sensor 38. The sensor 38 may be provided outside the control box 30.

Belt Body 13

As described above, the belt body 13 includes a first belt 16, a second belt 17 and a joining member 18. One end portion 16a side of the first belt 16 is wound on the drive pulley 35 and is fixed. The other end portion 16b side of the first belt 16 is fixed to the joining member 18. Upon the first belt 16 being wound on the drive pulley 35, the joining member 18 is pulled up. Upon the joining member 18 being forcibly pulled down, the first belt 16 is unwound (pulled out) from the drive pulley 35. An amount of winding or unwinding (pullout) of the first belt 16 in the drive pulley 35 and an amount of rotation of an output shaft of the motor 33 are correlated with each other. A parameter relating to rotation of the motor 33 accompanying winding or unwinding of the belt body 13 is detected by the rotation detector 36.

As described above, the joining member 18 is formed by a rectangular ring-like body. A shaft portion 27a on one side (upper side) of the ring-like body is a first attachment portion 27, and the end portion 16b of the first belt 16 is attached to the first attachment portion 27. In the present disclosure, the first belt 16 is undetachable from the first attachment portion 27, but may be detachable by use of, e.g., a buckle.

The other side (lower side) of the rectangular ring-like body forming the joining member 18 is a second attachment portion 28 for attaching the second belt 17. As described above, the joining member 18 includes the first attachment portion 27 for attaching the first belt 16 and the second attachment portion 28 for attaching the second belt 17.

The second attachment portion 28 supports the second belt 17 in such a manner that the second belt 17 is folded at an intermediate point (intermediate portion 17c) of the second belt 17. The second attachment portion 28 of the present disclosure includes a shaft portion 28a integrated with the first attachment portion 27, and a rotary pulley 29 rotatably supported on the shaft portion 28a. The second belt 17 is hung on the rotary pulley 29 so as to be folded at an intermediate point of the second belt 17. This configuration provides a configuration in which the second belt 17 is not fixed to the second attachment portion 28 but the second belt 17 is supported so as to be movable in both directions in the longitudinal direction (arrow X directions in FIG. 5) in a state in which the second belt 17 is folded.

In FIG. 2, the second belt 17 is attached to the second harnesses 12.

More specifically, the second belt 17 is formed of a single band-like member. One end portion 17a side of the second belt 17 is attached to the left second harness 12. The other end portion 17d side of the second belt 17 is attached to the right second harness 12. As above, the intermediate portion 17c of the second belt 17 is put on the joining member 18.

According to the above configuration of the second belt 17, the second belt 17 includes a left second belt portion 19 extending from the joining member 18 to the left second harness 12 and a right second belt portion 20 extending from the joining member 18 to the right second harness 12. As above (see FIG. 5), the second belt 17 is hung on the second attachment portion 28 (rotary pulley 29) and not fixed, a length of the left second belt portion 19 and a length of the right second belt portion 20 can freely be changed. However, a total of the length of the left second belt portion 19 and the length of the right second belt portion 20 is fixed. This configuration prevents, for example, walking of the user from being restricted by the second belt 17, and thus, enables the user to easily walk.

The second belt 17 further includes a connecting member 39 connecting the left second belt portion 19 and the right second belt portion 20. The connecting member 39 connects the left second belt portion 19 and the right second belt portion 20 at intermediate positions between the folded portion (intermediate portion 17c) of the second belt 17 and respective fixation parts of the two second harnesses 12 (one end portion 17a and the other end portion 17d). The folded portion is a part of the second belt 17, the part being folded at the joining member 18. The fixation portions are parts of the second belt 17, the parts being fixed to the two second harnesses 12, respectively.

For example, where the user changes his/her posture from an upright posture to a stooped posture as illustrated in FIG. 4, the connecting member 39 enables preventing an increase in lateral distance between the left second belt portion 19 and the right second belt portion 20. In other words, the connecting member 39 enables preventing a failure of the left second belt portion 19 and the right second belt portion 20 to extend along the respective back sides of the leg regions BL of the user.

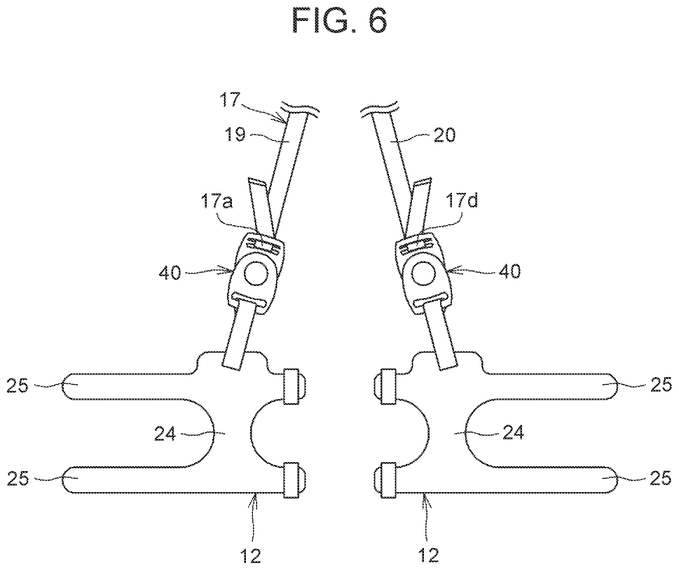

As illustrated in FIG. 6, the one end portion 17a side of the second belt 17 may be attached to the left-side second harness 12 via a fastener 40 such as a buckle. Also, the other end portion 17d side of the second belt 17 may be attached to the right-side second harness 12 via a fastener 40 such as a buckle. Consequently, the second belt 17 can be separated from the second harnesses 12.

Sensor 38 and Controller 15

In FIG. 5, as described above, the sensor 38 is formed by an acceleration sensor. The controller 15 can perform various types of arithmetic processing. By the controller 15 performing arithmetic processing of a signal from the sensor 38, a motion and a posture of the user can be detected. The sensor 38 has a configuration that outputs a signal according to a posture of the user, and thus functions as a posture detector for detecting a posture of the user. For example, it is possible to detect whether a posture of the upper body of the user is a forward-tilted posture or an upright posture or detect that the user has taken a crouching posture.

Also, an amount of winding and unwinding of the belt body 13 in the drive pulley 35 by the motor 33 and a posture of the user are correlated with each other. Therefore, the controller 15 can estimate a posture of the user based on a rotational angle of the motor 33 detected by the rotation detector 36. The rotation detector 36 functions as a posture detector for detecting a posture of the user.

The controller 15 processes a signal from one or each of both of the sensor 38 and the rotation detector 36, and outputs a drive signal to the actuator 14 (motor 33) based on a result of the processing, that is, the posture of the user. Based on the drive signal, the actuator 14 (motor 33) operates to, e.g., wind and unwind the belt body 13 and temporarily stop the winding and unwinding.

In a state in which the assist device 10 is worn by the user, the motor 33 constantly operates (generates torque) in a direction in which the belt body 13 is wound, with a force that is smaller than that of a case where the motor 33 generates an assist force, according to the control by the controller 15, to cause generation of small tension in the belt body 13. Consequently, the belt body 13 is not loosened.

Upon the user changing his/her posture, for example, from an upright posture to a forward-tilted posture, tension is generated in the belt body 13 because of the posture change. Therefore, in this case, upon a start of a posture change to a forward-tilted posture, the motor 33 is forcibly rotated (the motor 33 idles) by the tension of the belt body 13 irrespective of power of the actuator 14, and the belt body 13 is thereby unwound. Alternatively, upon a start of a posture change to a forward-tilted posture, the actuator 14 operates, that is, the motor 33 is driven to rotate to unwind the belt body 13.

On the other hand, upon the user changing his/her posture from a forward-tilted posture to an upright posture, the belt body 13 is about to be loosened because of the posture change. Therefore, in this case, upon a start of the posture change to an upright posture, in order to maintain tension acting on the belt body 13, the actuator 14 operates, that is, the motor 33 is driven to rotate, to wind the belt body 13.

In this way, by the user's posture change, the belt body 13 is wound or unwound. In the winding or the unwinding, the motor 33 actively or passively rotate by a predetermined rotational angle. The rotational angle at this time is detected by the rotation detector 36. In this way, an amount of operation of the actuator 14 (motor 33) in winding or unwinding of the belt body 13 due to the user's posture change is detected by the rotation detector 36. Then, the controller 15 acquires the amount of operation of the actuator 14 (rotational angle of the motor 33) in winding or unwinding of the belt body 13 due to the user's posture change, and based on the amount of operation, performs control of operation of the actuator 14 in order to provide an assist force to the user.

Attachment-Detachment Portion 41

The attachment-detachment portions 41 will be described. The attachment-detachment portions 41 have a function that detachably attaches the mechanical unit 49 (control box 30) to the first harness 11. FIG. 7 is a diagram for describing an example of the attachment-detachment portions 41. FIG. 7 illustrates a state in which the mechanical unit 49 is detached from the first harness 11. Each attachment-detachment portion 41 includes an elongated hole 42 that is long in a height direction relative to a left-right direction, and a projection portion 43 that is engageable with the elongated hole 42. In the form illustrated in FIG. 7, the elongated holes 42 are formed in the back body portion 21 of the first harness 11 and the projection portions 43 are provided at the base 31 of the mechanical unit 49.

FIG. 8 is a diagram for describing another example of the attachment-detachment portions 41. In the form illustrated in FIG. 8, the projection portions 43 are formed at the back body portion 21 of the first harness 11 and the elongated holes 42 are provided in the base 31 of the mechanical unit 49. As illustrated in FIGS. 7 and 8, it is only necessary that: the elongated holes 42 be provided in one of the first harness 11 and the mechanical unit 49; and the projection portion 43 be provided at the other of the first harness 11 and the mechanical unit 49. In the form illustrated in FIGS. 7 and 8, a plurality of (two) sets of an elongated hole 42 and a projection portion 43 are provided so as to be aligned in the left-right direction.

The form illustrated in FIG. 7 will be described. Each projection portion 43 includes a shaft portion 43a and a bulge portion 43b. The shaft portion 43a is a base portion on the base 31 side of the projection portion 43 and is a thin shaft-like part projecting from the base 31. The bulge portion 43b is a part on the distal end side (tip portion) of the shaft portion 43a and is thicker than the shaft portion 43a.

Each elongated hole 42 includes an enlarged hole portion 42b and a reduced hole portion 42a. The enlarged hole portion 42b is provided in an upper portion (one side in a longitudinal direction) of the elongated hole 42 and is set to have a size that enables the bulge portion 43b to pass through the enlarged hole portion 42b. The reduced hole portion 42a is provided in a lower portion (the other side in the longitudinal direction) of the elongated hole 42 and is set to have a size that in a state in which the shaft portion 43a is inserted in the reduced hole portion 42a, prevents the bulge portion 43b from passing through the reduced hole portion 42a. The enlarged hole portion 42b and the reduced hole portion 42a are connected and the enlarged hole portion 42b and the reduced hole portion 42a form one elongated hole 42. The elongated hole 42 has an inverted keyhole-like shape. Two such elongated holes 42 are provided in the first harness 11 so as to be aligned laterally. Each elongated hole 42 may be an elongated groove that does not extend through the back body portion 21 and is long in the height direction.

According to the above, the attachment-detachment portion 41 illustrated in FIG. 7 is configured as follows. In other words, in a state in which the projection portions 43 are located in the respective upper portions of the elongated holes 42, the projection portions 43 can be fitted in and separated from the respective elongated holes 42. In a state in which the projection portions 43 are fitted in the respective upper portions of the elongated holes 42, upon the mechanical unit 49 being brought down relative to the first harness 11 to locate the projection portions 43 in the respective lower portions of the elongated holes 42, the projection portions 43 and the lower portions of the elongated holes 42 engage with each other, which prevents separation between the elongated holes 42 and the projection portions 43. Consequently, the mechanical unit 49 is fixed to the first harness 11.

On the other hand, upon the mechanical unit 49 being brought up relative to the first harness 11 to locate the projection portions 43 in the respective upper portions of the elongated holes 42, it becomes possible to separate the projection portions 43 from the elongated holes 42. Consequently, the mechanical unit 49 is detached from the first harness 11.

The form illustrated in FIG. 8 will be described. Although the disposition of the elongated holes 42 and the projection portions 43 is a reverse of the form illustrated in FIG. 7, the elongated holes 42 and the projection portions 43 have respective shapes that are the same as those of the form illustrated in FIG. 7. However, the shape of the elongated holes 42 illustrated in FIG. 8 is a reverse, in terms of top and bottom, of the shape of the elongated holes 42 illustrated in FIG. 7. In other words, the elongated holes 42 have a keyhole-like shape. Two such elongated holes 42 are provided in the mechanical unit 49 side so as to be aligned laterally.

In the attachment-detachment portions 41 illustrated in FIG. 8, each projection portion 43 includes a shaft portion 43a and a bulge portion 43b. The shaft portion 43a is a base portion on the back body portion 21 side of the projection portion 43 and is a thin shaft-like part projecting from the back body portion 21. The bulge portion 43b is a part on the distal end side (tip portion) of the shaft portion 43a and is thicker than the shaft portion 43a.

Each elongated hole 42 includes an enlarged hole portion 42b and a reduced hole portion 42a. The enlarged hole portion 42b is provided in a lower portion (one side in a longitudinal direction) of the elongated hole 42 and is set to have a size that enables the bulge portion 43b to pass through the enlarged hole portion 42b. The reduced hole portion 42a is provided in an upper portion (the other side in the longitudinal direction) of the elongated hole 42 and is set to have a size that in a state in which the shaft portion 43a is inserted in the reduced hole portion 42a, prevents the bulge portion 43b from passing through the reduced hole portion 42a. The enlarged hole portion 42b and the reduced hole portion 42a are connected and the enlarged hole portion 42b and the reduced hole portion 42a form one elongated hole 42. Each elongated hole 42 may be an elongated groove that does not extend through the base 31 and is long in the height direction.

According to the above, the attachment-detachment portions 41 illustrated in FIG. 8 are configured as follows. In other words, in a state in which the projection portions 43 are located in the respective lower portions of the elongated holes 42, the projection portions 43 can be fitted in and separated from the respective elongated holes 42. In a state in which the projection portions 43 are fitted in the respective lower portions of the elongated hole 42, upon the mechanical unit 49 being brought down relative to the first harness 11 to locate the projection portions 43 in the respective upper portions of the elongated holes 42, the projection portions 43 and the upper portions of the elongated holes 42 engage with each other, which makes it impossible to separate the elongated holes 42 and the projection portions 43 from each other. Consequently, the mechanical unit 49 is fixed to the first harness 11.

On the other hand, upon the mechanical unit 49 being brought up relative to the first harness 11 to locate the projection portions 43 in the respective lower portions of the elongated holes 42, it becomes possible to separate the projection portions 43 from the elongated holes 42. Consequently, the mechanical unit 49 is detached from the first harness 11.

As above, in each of the forms illustrated in FIGS. 7 and 8, the mechanical unit 49 can be detached from the first harness 11 by use of the attachment-detachment portions 41. Note that although not illustrated, each attachment-detachment portion 41 may include a lock mechanism in order to prevent the mechanical unit 49 from easily coming off from the first harness 11. For example, the lock mechanism has a function that inhibits the projection portion 43 from moving relative to the elongated hole 42 in the height direction. Where the mechanical unit 49 is detached from the first harness 11, the lock mechanism is undone. Note that the elongated holes 42 and the projection portions 43 may have respective forms other than the illustrated forms.

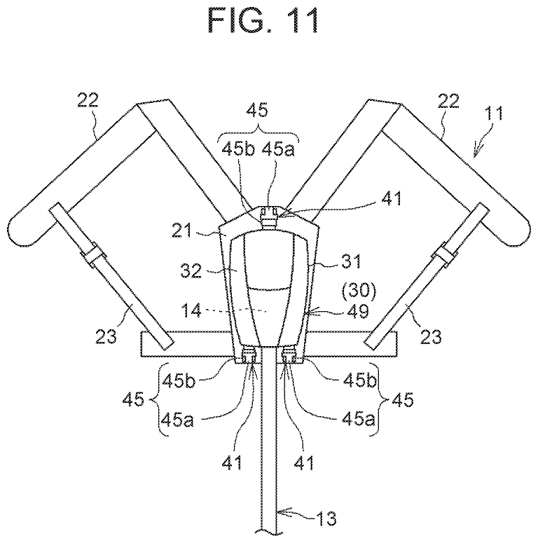

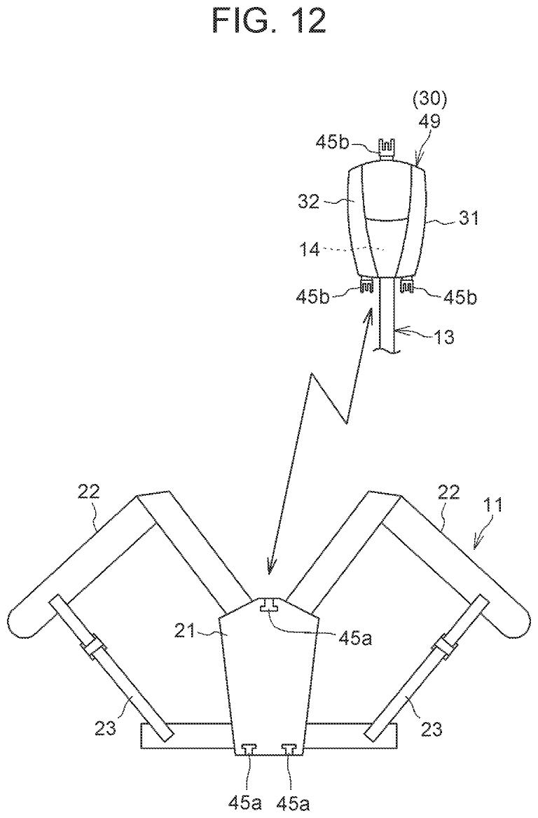

An alteration of the attachment-detachment portions 41 will be described. As illustrated in FIG. 11, each attachment-detachment portion 41 may be a fastener 45 such as a buckle. FIG. 12 is a diagram illustrating a state in which a mechanical unit 49 (control box 30) is detached from a first harness 11. Each fastener 45 includes a first member 45a, and a second member 45b that can be joined to and separated from the first member 45a. The first member 45a is fixed to a back body portion 21, which is a part of the first harness 11. The first members 45a are provided in upper and lower portions of the back body portion 21. In the illustrated example, the first members 45a are provided at one location in the upper portion of the back body portion 21 and two locations in the lower portion of the back body portion 21; however, the number and disposition can be changed. The second members 45b are fixed to a base 31, which is a part of the mechanical unit 49 (control box 30). The second members 45b are provided at respective positions corresponding to those of the respective first members 45a.

For the fasteners 45, commercially available buckles are employed. The fasteners 45 may have another form as long as such form includes a first member 45a and a second member 45b that can be joined to and separated from the first member 45a. The mechanical unit 49 can be detachably attached to the first harness 11 by use of the attachment-detachment portions 41 illustrated in FIGS. 11 and 12.

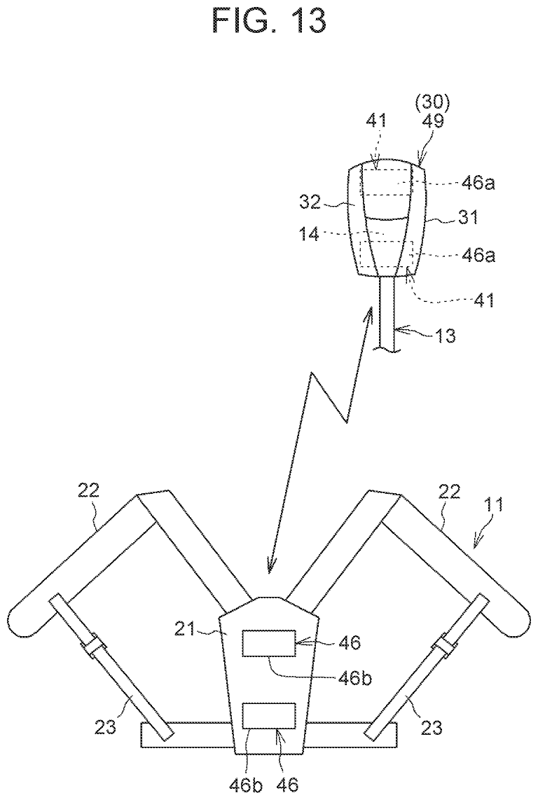

FIG. 13 is a diagram of another example of the attachment-detachment portions 41. Each of the attachment-detachment portions 41 illustrated in FIG. 13 is formed by a hook-and-loop fastener 46. FIG. 13 illustrates a state in which a mechanical unit 49 is detached from a first harness 11. The hook-and-loop fastener 46 includes a first member 46a including a hooked nap and a second member 46b including a looped nap, and the hooked nap and the looped nap can be joined to and separated from each other. One of the first member 46a and the second member 46b is fixed to a back body portion 21, which is a part of a first harness 11. The other of the first member 46a and the second member 46b is fixed to a base 31, which is a part of the mechanical unit 49 (control box 30).

A binding force of each hook-and-loop fastener 46 is strong in a direction along a surface of the hook-and-loop fastener, that is, a shearing direction. Therefore, the mechanical unit 49 is integrated with the first harness 11 against tension of a belt body 13. On the other hand, the binding force of each hook-and-loop fastener 46 is weak in a direction perpendicular to the surface (in comparison with the shearing direction). Therefore, the mechanical unit 49 can easily be detached (removed) from the first harness 11. The mechanical unit 49 is detachably attached to the first harness 11 by use of the attachment-detachment portions 41 illustrated in FIG. 13.

In each of the forms, the mechanical unit 49 can be detached from the first harness 11 by use of the attachment-detachment portions 41 (see FIGS. 7, 8 and 11 to 13). As means for separating the mechanical unit 49 from the first harness 11 other than the above-described attachment-detachment portions 41, a receiving portion 50 may be provided in a first harness 11 (see FIG. 14). In other words, where an assist force is necessary, a mechanical unit 49 is provided in the receiving portion 50 included in the first harness 11, and where no assist force is necessary, the mechanical unit 49 is detached from the receiving portion 50. Note that where an assist device 10 includes a receiving portion 50 instead of attachment-detachment portions 41, respective components (other than the attachment-detachment portions 41) included in the assist device 10 are the same as, for example, the respective components of the above-described assist device 10 illustrated in FIG. 2 and description of such components will be omitted here. Examples of the case where the mechanical unit 49 is detached includes, e.g., cases where the first and second harnesses 11, 12 are cleaned, the first and second harnesses 11, 12 are replaced, the mechanical unit 49 is replaced, and maintenance of the mechanical unit 49 is performed, in addition to, e.g., a case where no assist force is necessary depending on the work and a case where a user takes a break.

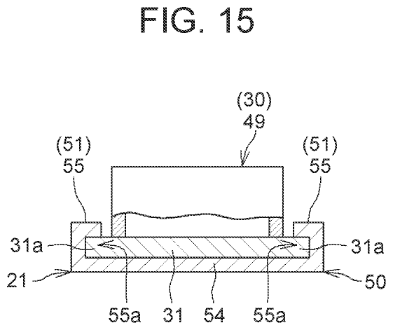

FIG. 14 is a diagram illustrating an example of the receiving portion 50 included in the first harness 11. FIG. 15 is a sectional view along line XV-XV in FIG. 14. FIG. 14 illustrates a state in which the mechanical unit 49 is detached from the receiving portion 50 and FIG. 15 illustrates a state in which the mechanical unit 49 is attached to the receiving portion 50.

The mechanical unit 49 (control box 30) includes a plate-like base 31. A back body portion 21 of the first harness 11 includes the receiving portion 50. The receiving portion 50 includes a plate-like portion 54 provided on the back side of a user and side guides 55 provided at the left and the right of the plate-like portion 54.

As illustrated in FIG. 15, each side guide 55 includes a groove 55a formed between the side guide 55 and the plate-like portion 54. Left and right side portions 31a of the base 31 are fitted in the respective grooves 55a. The side guides 55 have respective shapes that cover the base 31 from opposite, left and right, sides, and make the side portions 31a of the base 31 be sandwiched between the side guides 55 and the plate-like portion 54 in a front-rear direction. As illustrated in FIG. 14, a lateral distance between the side guides 55, 55, that is, a lateral distance between the grooves 55a, 55a become smaller toward a bottom. The base 31 of the mechanical unit 49 has a shape corresponding to the lateral distance between the grooves 55a, 55a. In other words, a width in a left-right direction of the base 31 becomes smaller toward a bottom.

The distance between the side guides 55, 55 becomes larger toward a top, and a part between the side guides 55, 55 opens upward. This opening forms an opening portion 52 of the receiving portion 50. The base 31 of the mechanical unit 49 is inserted between the left and right grooves 55a, 55a through the opening portion 52. In a state in which the side portions 31a of the base 31 are fitted in the respective grooves 55a, movement in the front-rear direction of the mechanical unit 49 is restricted. Furthermore, the lateral distance between the grooves 55a, 55a and the width in the left-right direction of the base 31 become smaller toward the respective bottoms. Therefore, in a state in which the side portions 31a of the base 31 are fitted in the respective grooves 55a, downward movement of the mechanical unit 49 is restricted by the side guides 55, 55. Consequently, the mechanical unit 49 is attached to the first harness 11.

In this way, the side guides 55 function as a holding portion 51 that prevents the mechanical unit 49 from moving upward, forward and rearward. Note that the back body portion 21 further includes a bottom portion 53 (see FIG. 14) that is provided at a lower portion of the plate-like portion 54 and projects rearward. The mechanical unit 49 may be prevented from moving downward relative to the back body portion 21, by the base 31 of the mechanical unit 49 coming into contact with the bottom portion 53. In this case, the bottom portion 53 is included in the holding portion 51. Where the bottom portion 53 is provided, an opening that allows a belt body 13 to extend through the opening is provided in the bottom portion 53.

In this way, the receiving portion 50 includes the holding portion 51 that prevents the received mechanical unit 49 from moving in the user's own downward, forward and rearward directions, and an opening portion 52 that is provided at an upper portion and from which the mechanical unit 49 is put in and taken out.

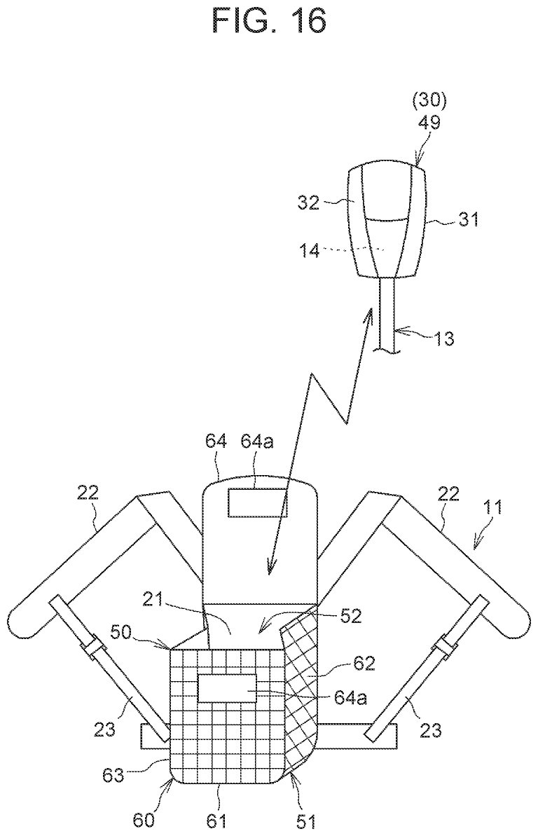

FIG. 16 is a diagram illustrating an alteration of the receiving portion 50. The receiving portion 50 illustrated in FIG. 16 is formed by a bottomed bag structure 60. A mechanical unit 49 (control box 30) is received in the bag structure 60. The bag structure 60 opens upward. The bag structure 60 includes left and right wall portions 62 and a rear wall portion 63 in addition to a back body portion 21 facing the back of a user and a bottom portion 61 provided so as to be continuous with a lower portion of the back body portion 21. The bag structure 60 is made of, for example, fabric and is light in weight.

The bottom portion 61, the left and right wall portions 62, the back body portion 21 and the rear wall portion 63 prevent the mechanical unit 49 received in the bag structure 60 from moving downward, forward, rearward, leftward and rightward. In other words, the bottom portion 61, the left and right wall portions 62, the back body portion 21 and the rear wall portion 63 form a holding portion 51 that prevents the received mechanical unit 49 from moving downward, forward and rearward. Then, the mechanical unit 49 can be put in and taken out from an opening portion 52 provided at an upper portion of the bag structure 60. An opening that allows a belt body 13 to extend through the opening is provided in the bottom portion 61 of the bag structure 60. The bag structure 60 includes a cover 64 and the cover 64 is fixed to the rear wall portion 63 by a hook-and-loop fastener 64a.

In each of the forms of the assist devices 10 with attachment-detachment portions 41 or a receiving portion 50 included in the first harness 11, where the mechanical unit 49 is detached from the first harness 11, the fasteners 40 (see FIG. 2) of the belt body 13 are unfastened. Consequently, the mechanical unit 49 can be detached from the first harness 11 and the second harnesses 12, together with the belt body 13.

Attachment Structures of Shoulder Belts 22 and Underarm Belts 23

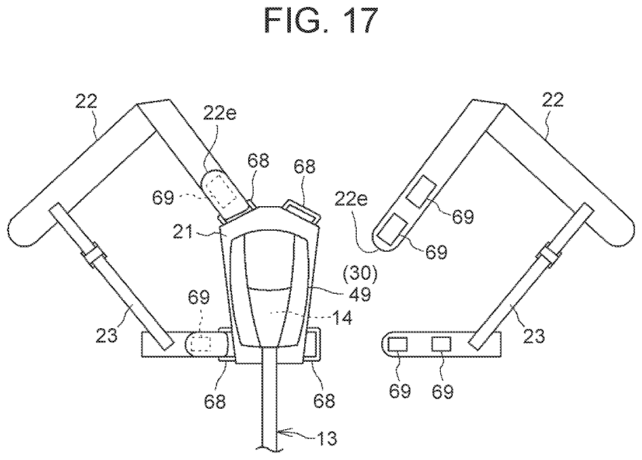

FIG. 17 is a diagram illustrating structures of attachment between shoulder belts 22 and underarm belts 23, and a back body portion 21 in a first harness 11. The back body portion 21 includes a plurality of ring-like members 68. In the present disclosure, a ring-like member 68 is provided at each of four, upper, lower, left and right, portions of the back body portion 21. In FIG. 17, the shoulder belt 22 and the underarm belt 23 on the left side are attached to the back body portion 21 and the shoulder belt 22 and the underarm belt 23 on the right side are detached from the back body portion 21.

Each shoulder belt 22 includes a hook-and-loop fastener 69 at a tip portion. A distal end 22e of the shoulder belt 22 is folded back through a ring-like member 68. Consequently, the tip portion of the shoulder belt 22 has a looped shape and the looped shape is kept by the hook-and-loop fastener 69. Consequently, the shoulder belt 22 is attached to the back body portion 21. The shoulder belt 22 can be detached from the back body portion 21 by unfastening the hook-and-loop fastener 69. The shoulder belt 22 detached from the back body portion 21 thus can be, for example, washed. The attachment structure including a hook-and-loop fastener 69 and a ring-like member 68 is applied also to the underarm belts 23.

The attachment structures for the shoulder belts 22 and the underarm belts 23 can be applied to each of the respective forms of the assist devices 10 including attachment-detachment portions 41 and the respective forms of the assist devices 10 including a receiving portion 50.

Assist Force of Assist Device 10

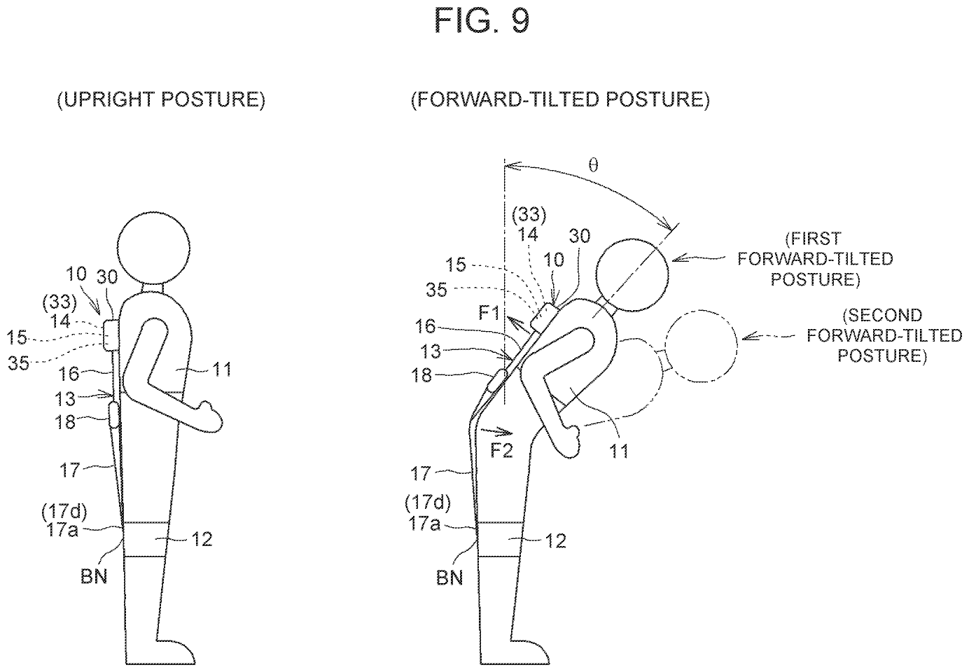

FIG. 9 is a diagram of a case where the user wearing the assist device 10 changes his/her posture. The assist device 10 can provide an assist force to the user for the posture change.

Upon the first belt 16 being wound on the drive pulley 35 by the motor 33 of the actuator 14, the joining member 18 pulls the second belt 17 up toward the actuator 14 side, that is, the upper side. The opposite end portions 17a, 17d of the second belt 17 are attached to the left and right second harnesses 12, respectively. The second harnesses 12 are fixed to the respective knee regions BN. Therefore, upon the first belt 16 being wound on the drive pulley 35, tension acts on the first belt 16 and the second belt 17. The tension acts as an assist force for the user.

A case where the user changes his/her posture from an upright posture to a forward-tilted posture will be described. Upon a start of the posture change to a forward-tilted posture, the actuator 14 unwinds the belt body 13. Alternatively, the belt body 13 is unwound irrespective of power of the actuator 14. Consequently, the user can effortlessly take a forward-tilted posture. Upon a forward-tilting angle of the upper body of the user relative to a vertical line reaching θ and the user stopping at the tilting angle of θ, the unwinding of the belt body 13 is stopped. Note that a start and an end of a posture change can be detected by the rotation detector 36 or the sensor 38.

Upon the user starting to change his/her posture in a direction from a forward-tilted posture to an upright posture, the actuator 14 winds the belt body 13. Consequently, tension is generated in the belt body 13. The tension causes generation of a rearward acting force F1 in the first harness 11. In other words, an acting force F1 is generated in a direction in which the upper body of the user having a forward-tilted posture is raised. Also, simultaneously, in the second belt 17, an acting force F2 pushing a left hip region and a right hip region of the user forward is generated by the tension. Consequently, the user can easily return from the forward-tilted posture to an upright posture.

Also, as illustrated in FIG. 4, where the user takes a bent posture (crouching posture) in which the upper body is tilted forward and the knee regions are bent, the assist device 10 can provide an assist force to the user. Where the user changes his/her posture from a bent posture to an upright posture, for example, where the user lifts up an object or a part of the body of a care-receiver, the actuator 14 winds the belt body 13.

Consequently, tension is generated in the belt body 13.

The tension causes generation of a rearward acting force F1 in the first harness 11. In other words, an acting force F1 in a direction in which the upper body of the user having a forward-tilted posture is raised is generated. Also, simultaneously, in the second belt 17, an acting force F2 pushing the left hip region and the right hip region of the user forward is generated by the tension. Furthermore, a rearward acting force F3 is generated in the second harnesses 12. The above acting forces F1, F2, F3 reduce a load on muscles such as the back muscle, the quadriceps, etc., of the user having a stooped posture and thus enables assisting a motion of lifting up a load.

The assist device 10 also functions where the user changes his/her posture from an upright posture into a bent posture, for example, where the user lifts down an object or a part of the body of a care-receiver. In this case, the actuator 14 unwinds the belt body 13 while exerting a braking force for the unwinding of the belt body 13. In other words, the motor 33 rotates in a direction in which the belt body 13 is unwound, but torque in the winding direction is generated in the motor 33. Consequently, tension is generated in the belt body 13. In this case, also, the assist device 10 enables reducing a load on muscles such the back muscle, the quadriceps, etc., of the user in a stooped posture and thus enabling assisting a lift-down motion by means of the above acting forces F1, F2, F3. As above, the assist device 10 of the present disclosure enables reducing a load on the muscles of the waist region in a stooped posture and preventing lower back pain.

Also, according to the assist device 10 of the present disclosure, even if the user has a bent posture with one of the left and right leg regions BL on the front side and the other on the rear side (in a laterally asymmetrical state), one (on the side on which the leg region is put forward) of the left second belt portion 19 and the right second belt portion 20 of the second belt 17 can automatically become longer than the other. Upon the first belt 16 being wound by the actuator 14 in this state, tension also acts on the second belt 17, and the tension acts on both of the left second belt portion 19 and the right second belt portion 20 and thus the tension is not relieved. Therefore, as described above, even if the user has a laterally asymmetrical posture, the assist device 10 of the present disclosure enables a proper assist force to act on the user.

Where the user maintains a forward-tilted posture, also, the assist device 10 of the present disclosure enables easily maintaining the posture. In other words, as illustrated in the figure on the right side of FIG. 9, in a state in which the user has taken a first forward-tilted posture, the operation of the actuator 14 stops to prevent unwinding of the belt body 13. Even if the user attempts to take a further forward-tilted posture (second forward-tilted posture), tension of the belt body 13 connecting the first harness 11 and the second harnesses 12 prevents taking the second forward-tilted posture. In other words, the assist device 10 attempts to maintain the first forward-tilted posture of the user. For the user, it is easy to maintain the first forward-tilted posture. As a result, for example, where the user continues having the first forward-tilted posture for a long time for work, a load on the body can be reduced.

Assist Device 10 of the Present Disclosure

As above, the assist device 10 of the present disclosure (see FIG. 2) includes the first harness 11 to be fitted to shoulder regions BS of a user, the second harnesses 12 to be fitted to left and right leg regions BL of the user, respectively, the belt body 13, and the actuator 14. The belt body 13 is provided so as to extend to the first harness 11 and to the second harnesses 12 along the back side of the user. The actuator 14 is provided in the first harness 11 and is configured to be capable of winding and unwinding a part of the belt body 13.

The belt body 13 includes the first belt 16 to be wound and unwound by the actuator 14, the second belt 17 attached to the second harnesses 12, and the joining member 18 joining the first belt 16 and the second belt 17.

According to this assist device 10, the belt body 13 is provided so as to extend to the first harness 11 and to the second harnesses 12 along the back side of a user. By the actuator 14 winding the belt body 13 (first belt 16), tension acts on the first belt 16 and the second belt 17. The tension causes generation of an assist force for assisting the user's work, which reduces a burden on the body of the user.

For example, when a user (caregiver) changes his/her posture from a forward-tilted posture to an upright posture while holding a load (care-receiver) with his/her hands (see FIG. 9), tension acts on the belt body 13 by the actuator 14 winding the belt body 13. The tension makes it easy for the user to change his/her posture from a forward-tilted posture to an upright posture and thus reduces a burden on the body of the user. In other words, tension acting on the belt body 13 is generated by the actuator 14 as an assist force.

Upon the user walking with the second harnesses 12 attached to the leg regions BL of the user and the belt body 13 tensed, the leg regions BL may be pulled by the belt body 13. In the second belt 17, if each of the length of the left second belt portion 19 and the length of the right second belt portion 20 is always constant and fixed, the user may feel discomfort in walking. Therefore, in the present disclosure, the one end portion 17a side of the second belt 17 is attached to the left second harness 12 and the other end portion 17d side of the second belt 17 is attached to the right second harness 12. Then, the second attachment portion 28 included in the joining member 18 supports the second belt 17 in such a manner that the second belt 17 is folded at an intermediate point of the second belt 17 and movable in the longitudinal direction.

With this configuration, when the user walks, the length of the left second belt portion 19 and the length of the right second belt portion 20 change in the second belt 17. Therefore, the user can easily walk.

Furthermore, in the present disclosure, as illustrated in FIG. 5, the second attachment portion 28 of the joining member 18 includes the rotary pulley 29 supported on the shaft portion 28a integrated with the first attachment portion 27. The second belt 17 is hung on the rotary pulley 29 so as to be folded at an intermediate point of the second belt 17. Therefore, when the user walks, the length of the left second belt portion 19 and the length of the right second belt portion 20 easily change and thus the user can more easily walk.

The assist device 10 of the present disclosure further includes the attachment-detachment portions 41 that detachably attach the mechanical unit 49 including the above-described actuator 14 to the first harness 11. The attachment-detachment portions 41 are provided in the first harness 11 and the mechanical unit 49. The attachment-detachment portions 41 enable detachment of the mechanical unit 49 from the first harness 11. Therefore, where no assist force of the actuator 14 is necessary, the user can be relieved of a burden by detaching the mechanical unit 49 from the first harness 11 without taking off the assist device 10 itself. Then, where an assist force becomes necessary, the user only needs to attach the mechanical unit 49 to the first harness 11 worn by the user, by use of the attachment-detachment portions 41. Therefore, it becomes possible to quickly respond to work needing an assist force.

In the assist device 10 having such configuration as above, tension acting on the belt body 13 in generating an assist force contains a component in the height direction. Therefore, each of the attachment-detachment portions 41 includes an elongated hole 42 that is long in the height direction and a projection portion 43. The elongated hole 42 is provided in one of the first harness 11 and the mechanical unit 49. The projection portion 43 is engageable with the elongated hole 42 and is provided at the other of the first harness 11 and the mechanical unit 49. Then, the elongated hole 42 has the following shape.

Shape of the elongated hole 42: “shape that, in a state in which the projection portion 43 is located on one side in the longitudinal direction (the upper portion in FIG. 7 and the lower portion in FIG. 8) of the elongated hole 42, enables the projection portion 43 to be fitted in and separated from the elongated hole 42 and in a state in which the projection portion 43 is located on the other side in the longitudinal direction (the lower portion in FIG. 7 and the upper portion in FIG. 8) of the elongated hole 42, prevents separation between the elongated hole 42 and the projection portion 43”.

With this configuration, during tension acting on the belt body 13 in order to provide an assist force, the mechanical unit 49 is pulled downward and the projection portions 43 are kept located on the other side in the longitudinal direction (the lower portions in FIG. 7 and the upper portions in FIG. 8) of the respective elongated holes 42. Therefore, the mechanical unit 49 does not drop off from the first harness 11. When the assist force becomes unnecessary, the mechanical unit 49 is moved upward relative to the first harness 11 to move the projection portions 43 to the one side in the longitudinal direction (the upper portions in FIG. 7 and the lower portions in FIG. 8) of the respective elongated holes 42. Consequently, the mechanical unit 49 can be detached from the first harness 11. In this way, the above configuration facilitates work of detaching the mechanical unit 49 from the first harness 11. Also, where the mechanical unit 49 is attached to the first harness 11, it is only necessary that each projection portion 43 be located on one side in the longitudinal direction (the upper portion in FIG. 7 and the lower portion in FIG. 8) of the corresponding elongated hole 42 and then be moved to the other side in the longitudinal direction (the lower portion in FIG. 7 and the upper portion in FIG. 8), and work of attaching the mechanical unit 49 to the first harness 11 is thus facilitated.

In each of the forms illustrated in FIGS. 7 and 8, a plurality of sets of an elongated hole 42 and a projection portion 43 are provided so as to be aligned in the left-right direction. Therefore, even if a load biased in the left-right direction acts on the mechanical unit 49 from the belt body 13, the mechanical unit 49 attached to the first harness 11 does not easily rotate. Therefore, a posture of the mechanical unit 49 is stabilized, enabling generation of a desired assist force.

As illustrated in FIG. 6, in the assist device 10 of the present disclosure, the belt body 13 (second belt 17) and the second harnesses 12 are connected via the fasteners 40. The fasteners 40 enables the belt body 13 (second belt 17) to be separated from the second harnesses 12. Separating the belt body 13 and the second harnesses 12 from each other by use of the fasteners 40 enables the belt body 13 and the mechanical unit 49 to be easily detached together from the first harness 11 and the second harnesses 12. The second belt 17 of the belt body 13 can be removed, enabling washing of the second belt 17.

As illustrated in FIGS. 11 to 13, each of the attachment-detachment portions 41 may be a fastener 45 or a hook-and-loop fastener 46. Also, the assist device 10 may include a receiving portion 50 instead of the attachment-detachment portions 41 (see FIGS. 14 and 16). The receiving portion 50 may be provided in the first harness 11 or a second harness 12, can receive the mechanical unit 49 and enables the mechanical unit 49 to be taken out. In the assist device 10 of the present disclosure (see FIGS. 14 to 16), the receiving portion 50 is provided in the first harness 11. In the assist device 10, where an assist force of the actuator 14 is unnecessary, the user can be relieved of a burden by taking the mechanical unit 49 out from the receiving portion 50 without taking off the assist device 10 itself. Then, where the assist force becomes necessary, the user only needs to put the mechanical unit 49 in the receiving portion 50 of the first harness 11 worn by the user. Therefore, it becomes possible to quickly respond to work needing an assist force.

In the assist device 10 including the receiving portion 50 such as above, tension acting on the belt body 13 in generating an assist force contains a component in the height direction. Therefore, in the assist device 10 of the present disclosure, the mechanical unit 49 is provided in the first harness 11 and the receiving portion 50 includes the holding portion 51 that prevents the received mechanical unit 49 from moving downward, forward and rearward, and an opening portion 52 for putting in and taking out the mechanical unit 49, the opening portion 52 being provided at the upper portion.

With this configuration, during tension acting on the belt body 13 in order to provide an assist force, the mechanical unit 49 is pulled downward; however, the holding portion 51 restricts downward, forward and rearward movement of the mechanical unit 49. Therefore, the mechanical unit 49 does not drop off from the first harness 11. When the assist force becomes unnecessary, the mechanical unit 49 can be detached from the first harness 11 by moving the mechanical unit 49 upward relative to the receiving portion 50 and taking the mechanical unit 49 out from the opening portion 52. In this way, work of detaching the mechanical unit 49 from the first harness 11 is facilitated. Where the mechanical unit 49 is attached to the first harness 11, it is only necessary to put the mechanical unit 49 down into the receiving portion 50 from the opening portion 52. Work of attaching the mechanical unit 49 to the first harness 11 is easy.

Other Assist Devices 10

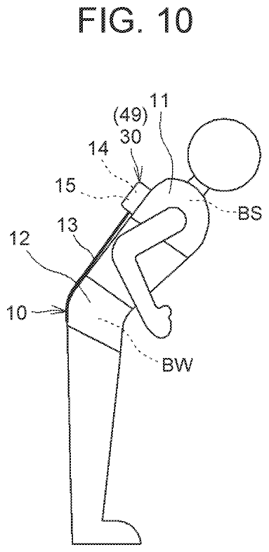

In the assist device 10 disclosed above, the second harnesses 12 are fitted to the leg regions BL of the user. As illustrated in FIG. 10, a second harness 12 may be fitted to a waist region BW of a user. In this case, the second harness 12 may have the shape of a waist belt or the shape of pants. Where a second harness 12 is fitted to a waist region BW, a mechanical unit 49 including an actuator 14 may be attached to a first harness 11 or may be attached to the second harness 12. In FIG. 10, the mechanical unit 49 including the actuator 14 is attached to the first harness 11.

In the case of the assist device 10 illustrated in FIG. 10, also, a belt body 13 is provided so as to extend to the first harness 11 and to the second harness 12 along the back side of the user. By the actuator 14 winding the belt body 13, tension acts on the belt body 13. The tension causes generation of an assist force for assisting the user's work, which reduces a burden on the body of the user.

Others

For prevention of pain in the lower back of a user, it is preferable that the second harnesses 12 be fitted to leg regions BL. This is because a load on a waist region BW can be reduced by the second harness 12 being fitted to leg regions BL. In each form of assist device 10, the belt body 13 is light in weight and can conform to the body of a user even if the user changes his/her posture, and thus follows movement of the user. Therefore, an assist device 10 that provides good wear comfort can be provided. Note that in the above disclosure, the control box 30 (mechanical unit 49) is provided on the rear side (back side) of a user in the first harness 11 but may be provided on the front side of a user. In this case, the belt body 13 is provided along the back of the user through shoulder regions BS of the user.

The linear form of the belt body 13 may be a form other than the illustrated form. For example, although not illustrated, as with the second attachment portion 28, a rotary pulley may be provided on the first attachment portion 27 of the joining member 18 and a first belt 16 may be hung on the rotary pulley so as to be folded at an intermediate point of the first belt 16. In this case, an end portion (on the side opposite to the drive pulley 35 side of the first belt 16) of the first belt 16 is attached to the first harness 11 (base 31). Alternatively, although not illustrated, a rotary pulley may be provided at the second harness 12 and a second belt 17 may be hung on the rotary pulley so as to be folded at an intermediate point of the second belt 17. In this case, opposite end portions of the second belt 17 are attached to a harness (third harness) to be fitted to a waist region SW.

The embodiment disclosed herein is a mere example in every respect and is not limiting. The scope of the right for the present disclosure is not limited to the above embodiment but includes all changes that come within the meaning and range of equivalency of the claims.

What is claimed is:

1. An assist device comprising:
a first harness configured to be fitted to at least one of a shoulder region and a breast region of a user;
a second harness configured to be fitted to a leg region or a waist region of the user;
a belt body provided so as to extend to the first harness and to the second harness along a back side of the user;
a mechanical unit including an actuator provided in one harness of the first harness and the second harness and configured to wind and unwind a part of the belt body; and
an attachment-detachment portion provided in the one harness and the mechanical unit and configured to detachably attach the mechanical unit to the one harness.

2. The assist device according to claim 1, wherein:
the mechanical unit is provided in the first harness;
the attachment-detachment portion includes an elongated hole that is provided in one of the first harness and the mechanical unit and is long in a height direction, and a projection portion provided at the other of the first harness and the mechanical unit and configured to engage with the elongated hole; and
the elongated hole has a shape configured to, in a state in which the projection portion is located on one side in a longitudinal direction of the elongated hole, allow the projection portion to be fitted in and separated from the elongated hole and configured to, in a state in which the projection portion is located on another side in the longitudinal direction of the elongated hole, prevent separation between the elongated hole and the projection portion.

3. The assist device according to claim 2, wherein:
the projection portion includes a thin shaft portion at a base portion of the projection portion and a bulge portion at a tip portion of the projection portion, the bulge portion being thicker than the shaft portion, and
the elongated hole includes a reduced hole portion on the other side in the longitudinal direction of the elongated hole, the reduced hole portion being configured to, in a state in which the shaft portion is inserted, prevent the bulge portion from passing through the reduced hole portion, and an enlarged hole portion on the one side in the longitudinal direction of the elongated hole, the enlarged hole portion being configured to allow the bulge portion to pass through the enlarged hole portion.

4. The assist device according to claim 2, wherein a plurality of sets each including the elongated hole and the projection portion are provided so as to be aligned in a left-right direction.

5. The assist device according to claim 2, wherein the belt body and the second harness are connected via a fastener configured to enable the belt body to be separated from the second harness.

6. An assist device comprising:
a first harness configured to be fitted to at least one of a shoulder region and a breast region of a user;
a second harness configured to be fitted to leg region or a waist region of the user;
a belt body provided so as to extend to the first harness and to the second harness along a back side of the user;
a mechanical unit including an actuator provided in one harness of the first harness and the second harness and configured to wind and unwind a part of the belt body; and
a receiving portion provided in the one harness and configured to receive the mechanical unit and configured to enable the mechanical unit to be taken out from the receiving portion.

7. The assist device according to claim 6, wherein:
the mechanical unit is provided in the first harness; and
the receiving portion includes a holding portion configured to prevent the received mechanical unit from moving in the user's own downward, forward and rearward directions, and an opening portion for putting in and taking out the mechanical unit, the opening portion being provided at an upper portion.
